(19) United States
(12) Patent Application Publication
(10) Pub. No.: US 2023/0154239 A1
(43) Pub. Date: May 18, 2023

(54) LANE ALLOCATION USING V2X TOLLING

(71) Applicant: FORD GLOBAL TECHNOLOGIES, LLC, Dearborn, MI (US)

(72) Inventors: Krishna BANDI, Farmington Hills, MI (US); Samer IBRAHIM, Dearborn, MI (US); Sathyanarayana Chary PALAKONDA, Northville, MI (US); Swetha SHAILENDRA, Royal Oak, MI (US)

(21) Appl. No.: 17/526,527

(22) Filed: Nov. 15, 2021

(51) Int. Cl. G07B 15/06; G08G 1/0967; G08G 1/01; G06Q 30/02; H04W 4/44; H04W 4/06

(52) U.S. Cl. CPC G07B 15/063; G08G 1/096783; G08G 1/0141; G08G 1/0145; G08G 1/0116; G06Q 30/0266; H04W 4/44; H04W 4/06

(57) ABSTRACT

A first toll advertisement message (TAM) is broadcast from a roadside unit (RSU), the first TAM indicating geographic locations of lanes of a roadway for which tolls are due and payment information for traversing the lanes of the roadway. A tolling usage message (TUM) is received from a first priority vehicle in receipt of the first TAM, the TUM including a request to reallocate one or more of the lanes of the roadway for use by the first priority vehicle. Responsive to receipt of the TUM, the RSU sends a TUM acknowledgment to the first priority vehicle indicating a lane allocation for use by the first priority vehicle and broadcasts a second TAM indicating the geographic locations of lanes of the roadway for which the tolls are due, the payment information for traversing the lanes of the roadway, and the lane allocation.

### TECHNICAL FIELD

Aspects of the present disclosure relate to using wireless tolling messages for allocation of road lanes to high priority vehicles.

### BACKGROUND

Vehicle-to-everything (V2X) is a type of communication that allows vehicles to communicate with various aspects of the traffic environment. This communication may include interacting with vehicles using vehicle-to-vehicle (V2V) communication and interacting with infrastructure using vehicle-to-infrastructure (V2I) communication.

Vehicles may include radio transceivers and vehicle on-board units (OBUs) to facilitate V2X communications. Road-side units (RSUs) may provide wireless communications from roadside infrastructure to the OBUs. Such communication may be referred to as infrastructure-to-vehicle (I2V) communication. RSUs generally operate in the same frequency band as V2X, over technologies such as Cellular Vehicle-to-Everything (CV2X) and Dedicated Short Range Communications (DSRC) technologies. Some RSUs provide additional functionality, such as local Wi-Fi hotspots for pedestrians or cellular backhaul to communicate information with a central system.

V2X tolling refers to electronic fee collection (EFC) toll charging. EFC may be supported by electronic equipment on-board of a vehicle configured for V2X communication. The V2X communications in support of EFC may include the exchange of information between various infrastructure elements.

### SUMMARY

In one or more illustrative examples, a system for smart tolling includes a transceiver configured to provide vehicle-to-everything (V2X) communication, and a road-side unit (RSU) including a hardware processor. The RSU is programmed to broadcast a first toll advertisement message (TAM), the first TAM indicating geographic locations of lanes of a roadway for which tolls are due and payment information for traversing the lanes of the roadway. The RSU is further programmed to receive a tolling usage message (TUM) from a first priority vehicle in receipt of the first TAM, the TUM including a request to reallocate one or more of the lanes of the roadway for use by the first priority vehicle. The RSU is further programmed to, responsive to receipt of the TUM, send a TUM acknowledgment to the first priority vehicle indicating a lane allocation for use by the first priority vehicle and broadcast a second TAM indicating the geographic locations of lanes of the roadway for which the tolls are due, the payment information for traversing the lanes of the roadway, and the lane allocation indicating which of the one or more of the lanes of the roadway are for use by priority vehicles.

In one or more illustrative examples, a method for smart tolling and lane allocation is provided. A first toll advertisement message (TAM) is broadcast from a road-side unit (RSU), the first TAM indicating geographic locations of lanes of a roadway for which tolls are due and payment information for traversing the lanes of the roadway. A tolling usage message (TUM) is received to the RSU from a first priority vehicle in receipt of the first TAM, the TUM including a request to reallocate one or more of the lanes of the roadway for use by the first priority vehicle. Responsive to receipt of the TUM, the RSU sends a TUM acknowledgment to the first priority vehicle indicating a lane allocation for use by the first priority vehicle and broadcast a second TAM indicating the geographic locations of lanes of the roadway for which the tolls are due, the payment information for traversing the lanes of the roadway, and the lane allocation indicating which of the one or more of the lanes of the roadway are for use by priority vehicles.

In one or more illustrative examples, a vehicle for smart tolling and lane allocation is provided. The vehicle includes a transceiver configured to provide vehicle-to-everything (V2X) communication. The vehicle also includes an on-board unit (OBU), including a hardware processor. The OBU is programmed to receive a first toll advertisement message (TAM) broadcast from a roadside unit (RSU), the first TAM indicating geographic locations of lanes of a roadway for which tolls are due and payment information for traversing the lanes of the roadway, send a tolling usage message (TUM) to the RSU, the TUM including a request to reallocate one or more of the lanes of the roadway for use by the vehicle, and receive, responsive to sending the TUM, a TUM acknowledgment indicating a lane allocation for use by the vehicle and a second TAM broadcast indicating geographic locations of lanes of a roadway for which tolls are due, payment information for traversing the lanes of the roadway, and the lane allocation indicating which of the one or more of the lanes of the roadway are for use by priority vehicles.

### BRIEF DESCRIPTION OF THE DRAWINGS

FIG. 1 illustrates an example system for the performance of V2X tolling and lane allocation transactions;

FIG. 2 illustrates further details of the system of FIG. 1;

FIG. 3 illustrates aspects of the OBU tolling application that is executed by the vehicle;

FIG. 4 illustrates aspects of the RSU tolling application that is executed by the RSU;

FIG. 5 illustrates an example of a toll road geometry including a request for a lane allocation for priority vehicles;

FIG. 6 illustrates an example of the toll road geometry implementing a lane allocation for priority vehicles;

FIG. 7 illustrates an example of the toll road geometry concluding the lane allocation for priority vehicles;

FIG. 8 illustrates an example of the toll road geometry after removal of the allocation of a lane for priority vehicles;

FIG. 9 illustrates an example process for the performance of V2X tolling and lane allocation transactions from an infrastructure perspective;

FIG. 10 illustrates an example process for the performance of V2X tolling and lane allocation transactions from a priority vehicle perspective;

FIG. 11 illustrates an example process for the performance of V2X tolling and lane allocation transactions from a non-priority vehicle perspective;

FIG. 12 illustrates an example of a computing device for use in the performance of V2X tolling transactions.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

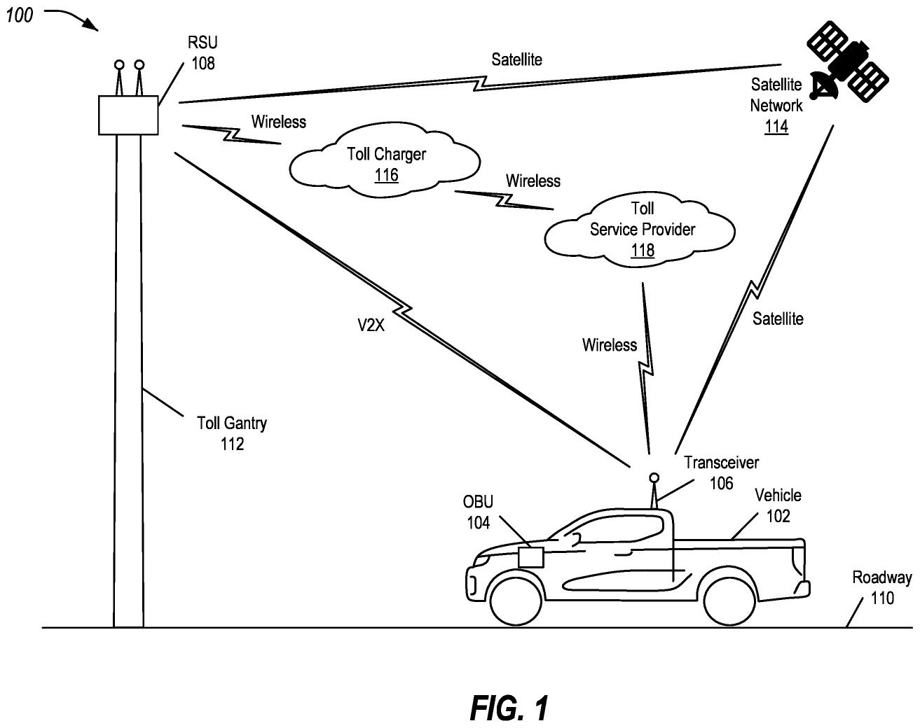

FIG. 1 illustrates an example system 100 for the performance of V2X tolling and lane allocation transactions. As shown, the system 100 includes a wireless-enabled vehicle 102 configured to travel along a roadway 110. The vehicle 102 includes an on-board unit (OBU) 104 and a transceiver 106. The system 100 also includes a toll gantry 112 that includes a RSU 108. The RSU 108 may communicate with a toll charger cloud 116 and/or a satellite network 114. The toll charger cloud 116 may also communicates with a toll service provider cloud 118. Using the OBU 104, the vehicle 102 may communicates with the RSU 108 over a broadcast peer-to-peer protocol (such as PC5), with toll service provider cloud 118 over a cellular connection, and with the satellite network 114 over a satellite connection. It should be noted that the system 100 shown in FIG. 1 is merely an example, and systems having more, fewer, and different arrangements of elements may be used.

The vehicle 102 may include various other types of passenger vehicles, such as sedans, crossover utility vehicles (CUVs), vans, sport utility vehicles (SUVs), trucks, recreational vehicles (RVs), scooters, or other mobile machines for transporting people or goods. In many cases, the vehicle 102 may be powered by an internal combustion engine. In such cases, the fuel source may be gasoline or diesel fuel. As another possibility, the vehicle 102 may be a hybrid electric vehicle (HEV) powered by both an internal combustion engine and one or more electric motors, such as a series hybrid electric vehicle, a parallel hybrid electric vehicle, or a parallel/series hybrid electric vehicle. As yet a further possibility, the vehicle 102 may be an electric vehicle (EV) powered by electric motors without an internal combustion engine. As the type and configuration of vehicles 102 may vary, the capabilities of the vehicles 102 may correspondingly vary. As some other possibilities, vehicles 102 may have different capabilities with respect to passenger capacity, towing ability and capacity, and storage volume. For title, inventory, and other purposes, the vehicle 102 may be associated with a unique identifier, such as a vehicle identification number (VIN).

The OBU 104 may be configured to provide telematics services to the vehicle 102. These services may include, as some non-limiting possibilities, navigation, turn-by-turn directions, vehicle health reports, local business search, accident reporting, and hands-free calling. The OBU 104 may be in communication with a transceiver 106. The OBU 104 may accordingly be configured to utilize the transceiver 106 to communicate over a cellular network over various protocols. For instance, the OBU 104 may access the cellular network via connection to one or more cellular towers. To facilitate the communications over the communications network, the OBU 104 may be associated with unique device identifiers (e.g., mobile device numbers (MDNs), Internet protocol (IP) addresses, etc.) to identify the communications of the OBU 104 on the communications network as being associated with the vehicle 102. The OBU 104 may, additionally, be configured to communicate over a broadcast peer-to-peer protocol (such as PC5), to facilitate V2X communications with devices such as the RSU 108. It should be noted that these protocols are merely examples, and different peer-to-peer and/or cellular technologies may be used.

The RSU 108 may be a device with processing capabilities and networking capabilities and may be designed to be placed in proximity of a roadway 110 for use in communicating with vehicles 102. In an example, the RSU 108 may include hardware configured to communicate over the broadcast peer-to-peer protocol (such as PC5), to facilitate V2X communications with the vehicles 102. The RSU 108 may also have wired or wireless backhaul capability to allow for communication with other elements of the communications network, such as the toll charger cloud 116.

The toll gantry 112 may be framework installed across the roadway 110. The toll gantry 112 may serve as a location to mount hardware to give the hardware a clear view of the roadway 110. In an example, the RSU 108 may be mounted to the toll gantry 112. It should be noted that, in other examples, the RSU 108 may be located along the ground adjacent to the roadway 110 and the toll gantry 112 may be omitted.

The OBU 104 may include global navigation satellite system (GNSS) functionality to allow the vehicle 102 to implement autonomous geo-spatial positioning for the vehicle 102. As some examples, the GNSS functionality may allow the vehicle 102 to determine its position using one or more satellite networks 114, such as global positioning system (GPS), GLONASS, Galileo, Beidou and/or others. The vehicle 102 may also be configured to utilize the transceiver 106 to perform other data communications with the satellite network 114.

The toll charger cloud 116 is a networked computing device or devices configured to perform operations in support of the functionality of the system 100. In an example, the toll charger cloud 116 may be programmed to perform operations in support of the payment aspects for use of the roadway 110 by the vehicle 102. In some examples, the system 100 may include different toll pay centers, where each toll charger cloud 116 is configured to handle payments for those vehicles 102 having accounts with the toll charger cloud 116. As one possibility, different vehicle 102 manufacturers may each maintain their own toll charger cloud 116. As another possibility, vehicles 102 may subscribe to the use of various third-party toll charger clouds 116.

The toll service provider cloud 118 is a networked computing device or devices configured to perform further operations in support of the functionality of the system 100. The toll service provider cloud 118 may be configured to perform operations such as providing payment information to the various toll pay centers with respect to the payments for usage of the roadway 110. For instance, the toll service provider cloud 118 may provide a toll schedule indicative of the payments of traversing the roadway 110, including payments for usage of different lanes (e.g., express, carpool, regular, etc.), usage for different classes of vehicles 102 (e.g., passenger cars, semi-trucks, etc.), usage for different times of day, and usage for high traffic vs low traffic situations. The toll service provider cloud 118 may also be configured to perform payment reconciliation operations, reporting functions, and may also provide information regarding vehicles 102 that are observed on the roadway 110 that may not have paid (e.g., as identified according to wireless transmissions of BSMs, pictures from cameras, etc.).

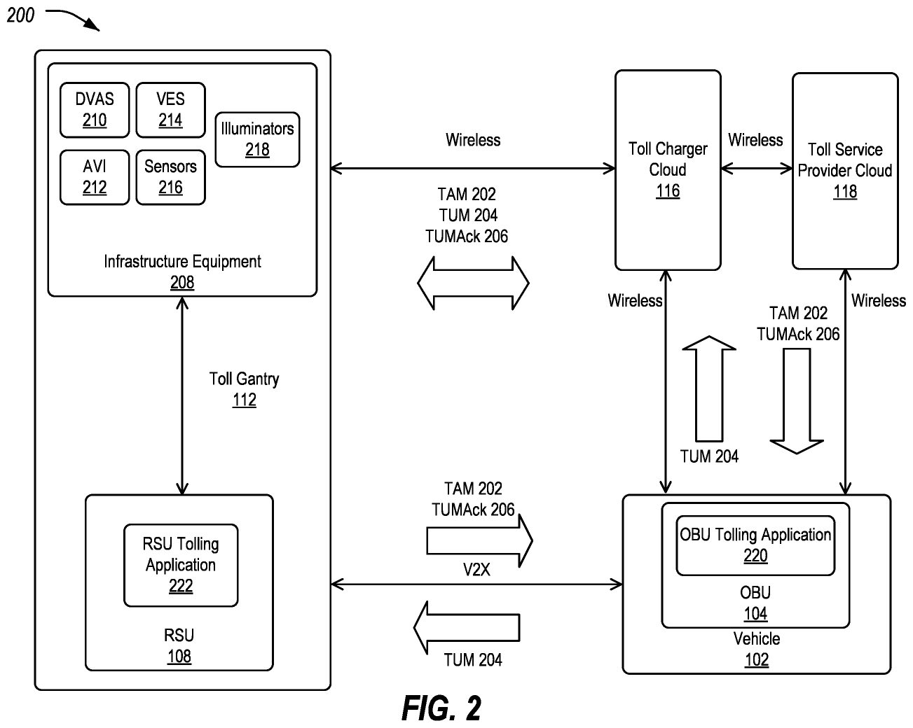

FIG. 2 illustrates further details of the system 100 of FIG. 1. The toll charger cloud 116, as mentioned above, is configured to levy tolls for vehicle 102 usage in a toll domain. The toll service provider cloud 118, as mentioned above, is configured to provide toll services in one or more toll domains.

As noted above, V2X tolling may refer to EFC toll charging supported by electronic equipment on-board of a vehicle 102 configured for V2X communication. These V2X communications may include the exchange of information between the infrastructure elements outlined herein. The exchange of information between the toll service user and the RSU 108 over PC5 or the toll service user and the toll service provider 120 (e.g., over Uu) may include a toll advertisement message (TAM) 202, a toll usage message (TUM) 204, a TUM acknowledgement (TUM-ACK) 206, and a toll receipt message (TRM). Generally, the TAM may include an advertisement of tolling information (e.g., tolling geometry and respective charges for respective vehicle 102 types at respective times). The TUM 204 may include usage information of the vehicle 102 used for charging the vehicle 102. The TUM 204 may include an identifier of the vehicle 102, which in turn may be used by the toll charger cloud 116 to determine the correct toll charger domain. (It should be noted that the system 100 may include multiple toll service provider cloud systems, where the different systems correspond with OEMs or vendors of toll services.) The TUM-ACK 206 may acknowledge that TUM 204 has been received. The TRM may include information regarding a receipt for usage of the resources being charged for.

Also as noted above, the toll gantry 112 may include the RSU 108. The toll gantry 112 may also include other infrastructure equipment 208 in support of the operation of the toll gantry 112. This may include, for example, a digital video audit system (DVAS) 210, automatic vehicle identification (AVI) 212, violation Enforcement systems (VES) 214, sensors 216 such as cameras and/or loops, and illuminators 218.

Tolling operations may be performed using the elements of the system 100. For instance, the toll service provider cloud 118 may send a toll rate schedule to the toll charger cloud 116. This toll rate table may include information that may be used to allow a vehicle 102 to understand the charges that may be incurred to traverse the roadway 110. In a simple example, the toll rate schedule may indicate that the payment to traverse the roadway 110 is a fixed tariff amount. However, in many examples, the payment, or tariff, to traverse the roadway 110 may vary according to various factors. For instance, travel in a first lane may incur a first charge, while travel in another lane may incur a second, different, charge. In another example, the payment may vary based on the number of occupants of the vehicle 102. In yet a further example, the payment may vary based on the type of vehicle 102 (e.g., a semitruck may incur a greater charge than a passenger car). In an even further example, payments may vary based on other factors, such as amount of traffic, time of day, day of week, and/or weather.

The toll charger cloud 116 may update rate details of the TAM 202. In an example, the toll service provider cloud 118 receives the toll rate schedule, identifies current rates, and updates rate information. This rate information may be cached at the toll charger cloud 116 and sent to the RSU 108. The RSU 108 may broadcast the rate information as well as other information in a TAM 202 message. This broadcast may be a periodic broadcast, such as a rebroadcast of the TAM 202 every 100 milliseconds.

The TAM 202 may include various information that may be useful for vehicles 102 in understanding usage of the roadway 110. This may include fields such as a timestamp indicative of the time at which the TAM 202 was created or sent.

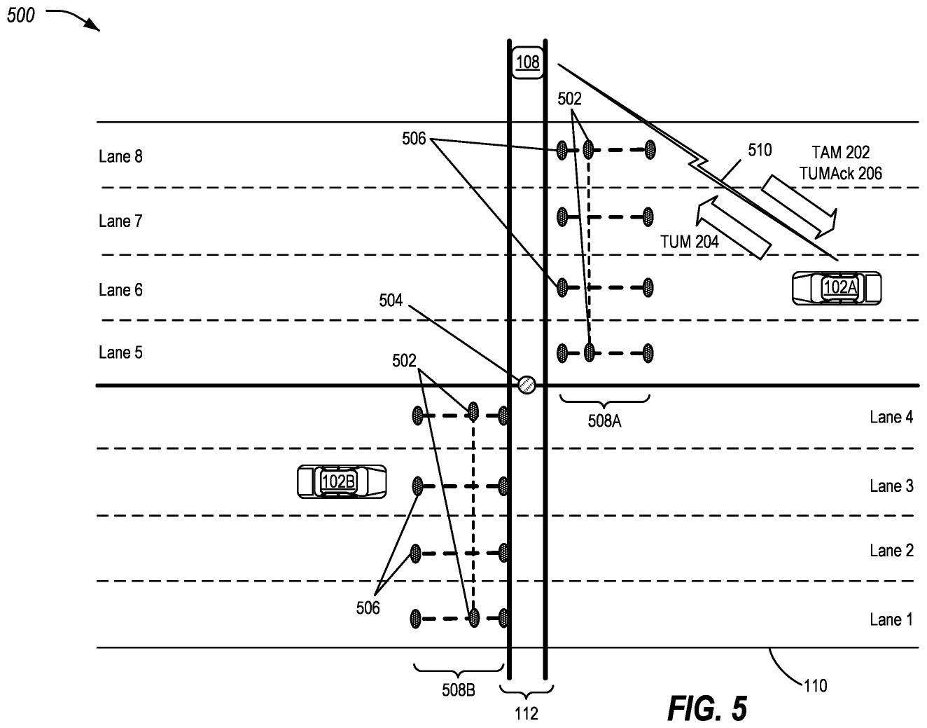

The TAM 202 may additionally include a toll charger identifier (ID) specifying which toll charger cloud 116 is to be used to perform the tolling operation. The TAM 202 may also include toll road geometry information with respect to the placement of lanes in a toll area. This may be useful in the generation of lane node offsets (e.g., shown in FIG. 5 as lane node offsets 502), as discussed in detail below. For instance, the TAM 202 may include a toll geometry reference, which may indicate a reference point from which locations of the tolling area may be computed (e.g., shown in FIG. 5 as reference point 504), as well as locations of toll trigger (e.g., shown in FIG. 5 as toll trigger lines 506) at which the vehicle 102 may be configured to send the TUM 204 to pay the toll. The TAM 202 may also include toll context data, such as times of day, carpool lanes, or other restrictions or context on the use of the roadway 110.

The TAM 202 may also include map information indicative of the layout of the roadway 110, such as an intersection geometry list and a road segment list. The road segment list includes various properties of the roadway, including lane description, high occupancy status, whether lanes are available 102 or are dedicated to high priority traffic, and so on. This information may include, for instance, indications of the layout of the lanes of the roadway 110, which may be used to allow vehicles 102 to identify when a tolled area is approached, as well as in which lane the vehicle 102 is traveling.

The OBU 104 of the vehicle 102 may receive the TAM 202 broadcast by the RSU 108. The vehicle 102 may log entry into the roadway 110. For instance, responsive to the geographic coordinates of the vehicle 102 matching one of the lanes of the roadway 110, the OBU 104 may identify that the vehicle 102 is entering a specific lane of the roadway 110. Knowing the lane of entry, the OBU 104 may then calculate the charge to be incurred by the vehicle 102. The OBU 104 may also generate a TUM 204.

The TUM 204 may include an identifier to uniquely identify the vehicle 102 to the system 100. The TUM 204 may also include information about the vehicle 102 entry to the toll area. For instance, the TUM 204 may include a timestamp the time when the TUM 204 was created, latitude, longitude, and elevation of the vehicle 102, positional accuracy of the latitude, longitude, and elevation, speed of the vehicle 102, and heading of the vehicle 102. The TUM 204 may also include other information, such as type of the vehicle 102, and an identifier of the toll charger cloud 116 or other charging information to use. The identifiers may be globally unique identifiers (GUIDs), to allow the toll charger servers and toll pay centers to be uniquely identified. The TUM 204 may also include an intersection identifier of the intersection through which the vehicle 102 entered the roadway 110, where the intersection identifier was received by the vehicle 102 in the TAM 202 (e.g., via the intersection geometry list and/or road segment list). The TUM 204 may also include a charge amount for the travel in the tolled area as determined by the vehicle 102 using the information in the TAM 202. Other information may also be included in the TUM 204, such as the distance traveled by the vehicle 102, a number of passengers in the vehicle 102, and a license plate number or other identifier of the vehicle 102.

The OBU 104 may send the TUM 204 to the RSU 108. The RSU 108 may forward the TUM 204 to the toll charger cloud 116. The toll charger cloud 116 may verify the vehicle 102 account and complete the transaction. The toll charger cloud 116 may accordingly generates a toll receipt message (TRM) to be returned to the vehicle 102.

The TRM may include various information determined by the toll charger cloud 116 in support of completion of the toll transaction performed with the vehicle 102. This information may include a message count (to help in identifying if any packet loss has occurred), the account identifier from the TUM 204, the timestamp the time when the TUM 204 was created, and an identifier of the toll charger cloud 116. The TRM may also include an intersection identifier of the intersection through which the vehicle 102 entered the roadway 110 (e.g., as indicated in the TUM 204 that was processed by the toll charger cloud 116), a lane identifier of which lane through which the vehicle 102 entered the roadway 110 (e.g., as indicated in the TUM 204 that was processed by the toll charger cloud 116), an intersection identifier of the intersection through which the vehicle 102 exited the roadway 110, and a lane identifier of which lane through which the vehicle 102 exited the roadway 110. The TRM may also include the vehicle type and the amount charged for access to the roadway 110. The toll charger cloud 116 may forward the TRM to the RSU 108. The RSU 108 may broadcast the TRM for receipt by the vehicle 102.

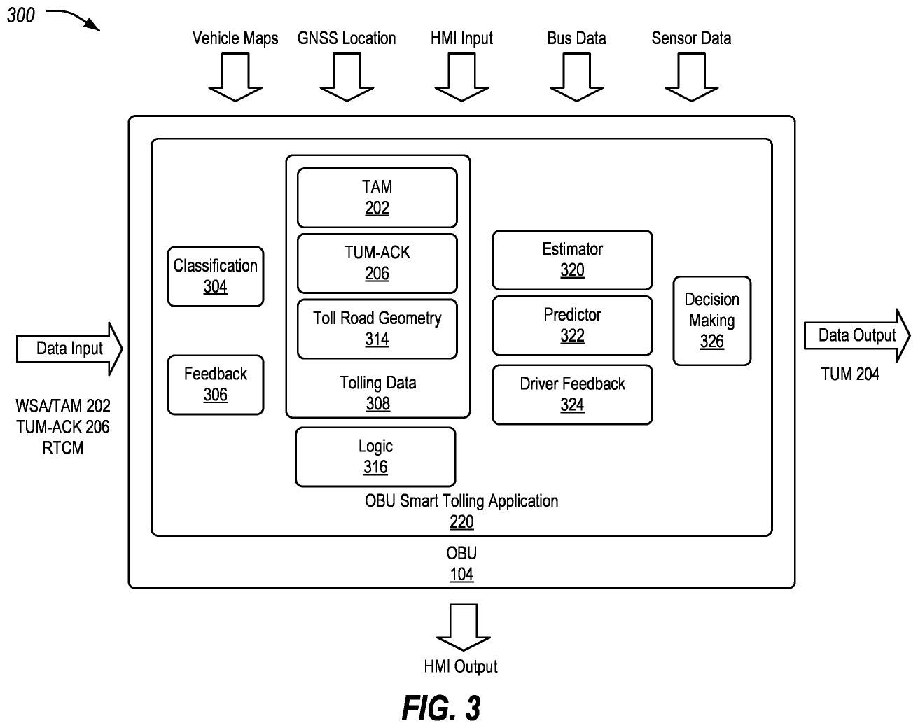

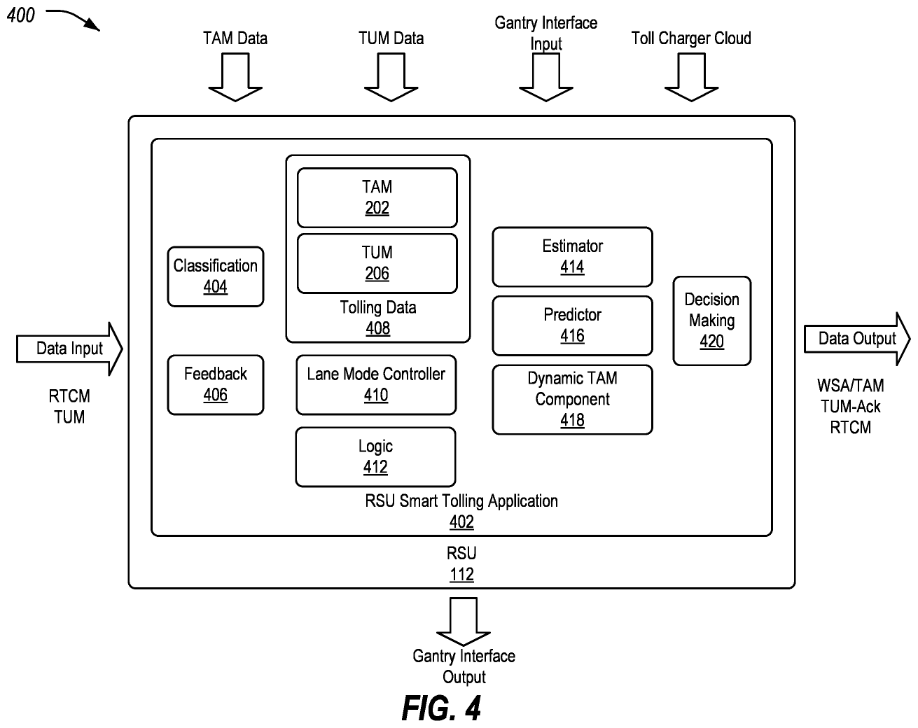

The vehicle 102 may include an OBU tolling application 220. Further aspects of the operation of the OBU tolling application 220 are discussed with respect to FIG. 3. The RSU 108 may include a RSU tolling application 222. Further aspects of the operation of the RSU tolling application 222 are discussed with respect to FIG. 4.

FIG. 3 illustrates aspects of the OBU tolling application 220 that is executed by the vehicle 102. With reference to FIG. 3, and with continuing reference to FIGS. 1-2, the OBU tolling application 220 may be programmed to allow the vehicle 102 to perform various smart tolling and lane allocation operations discussed in detail herein. In an example, the OBU tolling application 220 may be executed by one or more processors of the OBU 104.

The OBU tolling application 220 may receive various elements of data as input. In an example, these inputs may include TAMs 202 (as mentioned above), location information from GNSS, vehicle bus data from a vehicle controller area network (CAN) or other vehicle 102 bus, vehicle assistance information, in-built maps to aid in location of the vehicle 102 along the roadway 110, and TRMs.

The OBU tolling application 220 may provide various outputs as well. In an example, these outputs may include human machine interface (HMI) output provided to the HMI of the vehicle 102 for use by occupants of the vehicle 102, as well as TUMs 204 for use in charging the vehicle 102 and/or lane allocation via remote aspects of the system 100 discussed above.

The classification data 304 includes a classification of information received from various input sources, such as vehicle navigation MAPs, the vehicle bus, V2X messages (e.g., SPaT, MAP, SSM, BSM, EVA), vehicle GNSS, vehicle sensors (e.g., cameras, LIDAR, etc.). The feedback 306 includes aggregate feedback information received from the HMI of the vehicle 102, vehicle navigation MAPs, etc. The tolling data 308 includes the TAM 202 and TUM-ACK 206 data elements, as well as toll road geometry 314 indicative of layout information with respect to the roadway 110 lanes that the vehicle 102 intends to traverse. The logic 316 receives these data elements as input and performs the algorithm logic to produce outputs including driver feedback 324 to the vehicle 102 occupants and decision making for further broadcast of the TUM 204.

The estimator 320 performs a vehicle path estimation based on the tolling data 308 and the current path of the vehicle 102. In an example, the estimator 320 may identify the inbound lane of the vehicle 102 into the toll gantry 112 using Kalman filtering. In another example, the estimator 320 may identify the inbound lane of the vehicle 102 into the tolling area using a machine-learning model trained using various input data mentioned above to identify the vehicle path. The estimation may be performed based on the previous path history of vehicles 102, e.g., maneuvers of a driven path of vehicles 102. The predictor 322 performs vehicle 102 path prediction based on the classification data 304, tolling data 308, the estimated vehicle path determined by the estimator 320, and the intended exit lane from the gantry or tolling area. The driver feedback 324 includes the output information outputted from the logic 316 to share with the vehicle 102 driver.

FIG. 4 illustrates aspects of the RSU tolling application 222 that is executed by the RSU 108. With reference to FIG. 4, and with continuing reference to FIGS. 1-3, the RSU tolling application 222 may be programmed to allow the RSU 108 to perform various smart tolling and lane allocation operations discussed in detail herein. In an example, the RSU tolling application 222 may be executed by one or more processors of the RSU 108.

The RSU tolling application 222 may receive various elements of data as input. In an example, these inputs may include TAMs 202, TUMs 204, sensor information from the toll gantry 112 (e.g., from the DVAS 210, AVI 212, VES 214, sensors 216, etc.), and information from the toll charger cloud 116. The RSU tolling application 222 may provide various outputs as well. In an example, these outputs may include output to control aspects of the toll gantry 112 (e.g., the DVAS 210, AVI 212, VES 214, sensors 216, illuminators 218, etc.), as well as TUMs 204 for use in charging the vehicle 102 and/or lane allocation via remote aspects of the system 100 discussed above.

The classification data 404 includes a classification of information received from various input sources, such as the TAMs 202, TUMs 204, toll gantry 112 information, and toll charger cloud 116 information mentioned above. The feedback 406 includes aggregate feedback information received from the sensors of the toll gantry 112. The tolling data 308 includes the TAM 202 and TUM 204 data elements.

The lane mode controller 410 is configured to provide functionality to control which lanes of the roadway 110 are allocated to tolling, and which lanes of the roadway 110 are allocated to vehicles (such as ambulances, police cars, municipal vehicles, service vehicles, etc.) that are requesting preemption of tolling lanes for priority vehicle use. As used herein, priority vehicles refer to such vehicles requesting preemption of tolling lanes. To allow for the allocation of a lane for priority use, the lane mode controller 410 may be configured to adjust the TAM 202 information to indicate that a lane is unavailable for tolling but is available for priority vehicles 102. To allow for the deallocation of a lane from priority use, the lane mode controller 410 may be configured to adjust the TAM 202 information to indicate that a lane is again available for tolled vehicles 102.

The estimator 414 performs a vehicle path estimation based on the tolling data 408 and the current path of the vehicle 102. In an example, the estimator 414 may identify the inbound lane of the vehicle 102 into the toll gantry 112 using Kalman filtering. In another example, the estimator 414 may identify the inbound lane of the vehicle 102 into the tolling area using a machine-learning model trained using various input data mentioned above to identify the vehicle path. The estimation may be performed based on the previous path history of vehicles 102, e.g., maneuvers of a driven path of vehicles 102. The predictor 416 performs vehicle 102 path prediction based on the classification data 404, tolling data 408, the estimated vehicle path determined by the estimator 414, and the intended exit lane from the gantry or tolling area. In the case of a priority vehicle 102 requesting a lane reservation, the estimator 414 and predictor 416 may be used to control which lane should be allocated for priority vehicle use instead of tolled vehicle use.

The logic 412 is configured to receive the tolling data 408, classification data 404 and other data elements as input and performs the algorithm logic to produce outputs configured to control the lane mode controller 410 to provide dynamic TAM elements 418 in accordance with the allocation of lanes to priority traffic or tolling, e.g., as informed by the estimator 414 and predictor 416. In addition to the information specified in the TAM 202 as discussed above, the dynamic TAM elements 418 may specify which lanes are allocated for priority traffic and which lanes are allocated for tolling. These dynamic TAM elements 418 may be adjusted by the logic 412 for application to the TAM 202 by the lane mode controller 410.

FIG. 5 illustrates an example 500 of a toll road geometry including a request for a lane allocation for priority vehicles. As shown, the toll gantry 112 extends across lanes of a roadway 110. The lanes of the roadway 110 include, for example, in a first travel direction, a first lane, a second lane, a third lane, and a fourth lane. The illustrated roadway 110 further includes a center median, and lanes in a second travel direction, namely, a fifth lane, a sixth lane, a seventh lane, and an eighth lane. It should be noted that the particular roadway layout is merely an example. The RSU 108 is in operation in control of the toll gantry 112.

Lane node offsets 502 are also illustrated in the roadway 110. These lane node offsets 302 indicate geographic locations along the roadway with respect to a reference point 504 indicating the geographic location of the toll gantry 112. Which lane node offsets 502 to use may depend on the direction of travel of the vehicle 102. For example, the vehicle 102A is traveling in the second travel direction, and therefore may reference its location with respect to the lane node offsets 502 for the lanes in that travel direction (e.g., lanes five through eight). These lane node offsets 502 may make up a toll advertisement zone 508A for the second travel direction. The lane node offsets 502 for each lane may collectively define toll trigger lines 506 at which the vehicle 102 may be configured to pay the toll. As the vehicle 102B is traveling in the first travel direction, it therefore may reference its location with respect to the lane node offsets 502 for the lanes in that first travel direction (e.g., lanes one through four). These lane node offsets 502 may make up a toll advertisement zone 508B for the second travel direction.

In the illustrated example, the vehicle 102A may be a priority vehicle. A priority vehicle may, in some cases, include a municipal vehicle such as a police car, an ambulance, etc. In another example, the priority vehicle may be a service vehicle configured to provide aid to vehicles 102 along the roadway 110 that have encountered issues. In yet another example, the priority vehicle may be a bus, fleet vehicle or other type of vehicle having high priority to traverse the roadway 110 as compared to other vehicles such as the vehicle 102B.

The vehicle 102A may communicate its priority status to the RSU 108 as shown by the communication 510. This communication may include transmission of a priority request from the vehicle 102A to the RSU 108. This priority request may be included in a TUM 204 sent from the vehicle 102A to the RSU 108. In an example, the priority request may be sent from the OBU tolling application 220 via the OBU 104 using the transceiver 106 of the vehicle 102A. The priority request may be received using the communications functionality of the infrastructure equipment 208 of the toll gantry 112 and may be provided from the infrastructure equipment 208 to the RSU 108.

The vehicle 102A may send the priority request responsive to receipt of the TAM 202. For instance, the vehicle 102A may analyze the TAM 202 to determine whether any of the lanes of the roadway 110 in the travel direction of the vehicle 102 are allocated to priority vehicles. If so the vehicle 102A may utilize a priority lane. If not, the vehicle 102A may send the priority request.

Responsive to receipt of the priority request in the TUM 204, the RSU tolling application 222 of the RSU 108 may utilize the logic 412 to adjust the dynamic TAM elements 418 of the TAM 202. For instance, the RSU tolling application 222 may adjust the TAM 202 bring broadcast to indicate that one of the lanes in the travel direction of the vehicle 102A should be reallocated for priority vehicle use instead of for tolling vehicle use. The RSU 108 may then broadcast the updated TAM 202 to inform other vehicles 102 of the revised lane assignments. The RSU 108 may also send a TUM-ACK 206 message back to the vehicle 102A to inform it of the grant of a priority lane to the vehicle 102A.

In other examples, if the lane was already allocated for priority use, the TUM-ACK 206 may indicate a grant to use the existing allocated priority lane or lanes. For instance, when a second priority vehicle 102 is requesting via a TUM 204 for a lane reallocation, the RSU 108 may respond with the TUM-ACK 206 saying there is lane allocated for the first priority vehicle 102 that could be used by the second priority vehicle 102. However, in an example where the first and second vehicles 102 are of different priorities, such as a lower priority truck requesting a lane-reallocation after a higher priority vehicle 102 made a reallocation, then the RSU 108 via TUM-ACK 206 may indicate a current lane-reallocation for priority vehicles and therefore that the lower priority TUM 204 re-allocation may be rejected as current tolling gantry 112 RSU 108 is already using that lane to support a higher priority preemption of vehicles 102.

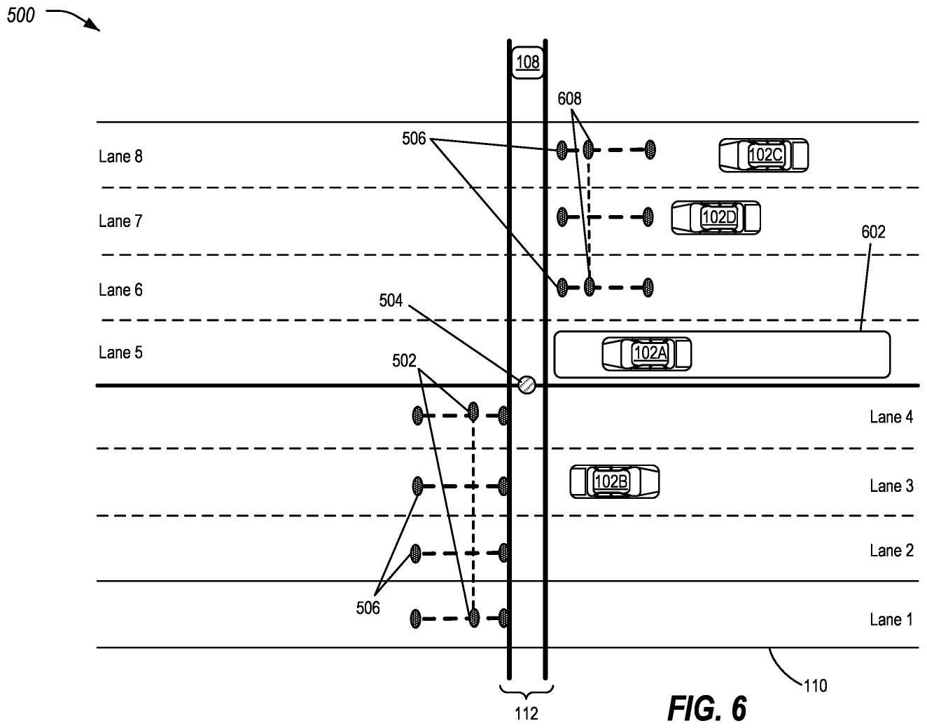

FIG. 6 illustrates an example 600 of the toll road geometry implementing a lane allocation for priority vehicles. As shown by lane allocation 602, lane five has been reallocated from tolling to use for priority vehicles. Thus, the vehicle 102A may utilize the lane allocation 602 to proceed through the toll gantry 112. Other vehicles in the same travel direction that are not priority vehicles (such as the vehicles 102C and 102D as shown), may continue to utilize lanes six, seven, and eight of the toll gantry 112, but may not use lane five.

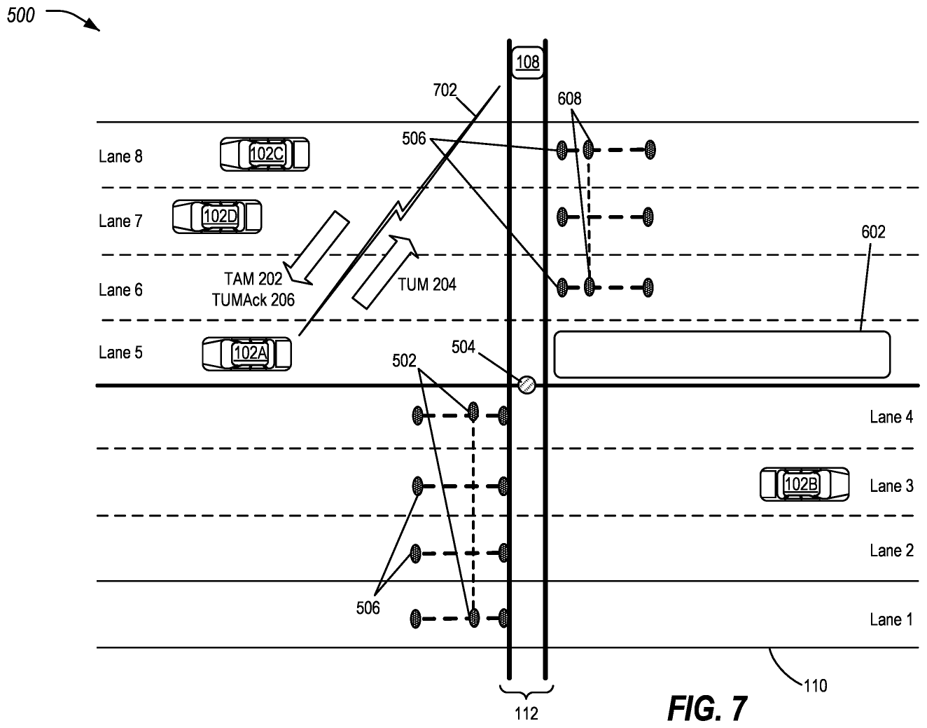

FIG. 7 illustrates an example 700 of the toll road geometry concluding the lane allocation for priority vehicles. For example, the vehicle 102A may communicate that the lane allocation is no longer required over communication 702. This communication may include transmission of a priority withdrawal request from the vehicle 102A to the RSU 108. This priority withdrawal request may be included in another TUM 204 sent from the vehicle 102A to the RSU 108. In an example, the priority withdrawal request may be sent from the OBU tolling application 220 via the OBU 104 using the transceiver 106 of the vehicle 102A. The priority withdrawal request may be received using the communications functionality of the infrastructure equipment 208 of the toll gantry 112 and may be provided from the infrastructure equipment 208 to the RSU 108.

The vehicle 102A may send the priority withdrawal request responsive to the vehicle 102A no longer requiring the priority lane. In one example, the vehicle 102A may require the priority lane for passage of the vehicle 102A through the toll gantry 112. In such an example, the vehicle 102A may send the priority withdrawal request responsive to passage of the vehicle 102A through the toll gantry 112. Or, in other examples, the vehicle 102A may desire to use the priority lane for passage of the vehicle 102A through the tolling area (or through at least one or more segments of the tolling are). In such a case, the lane allocation 602 may be maintained until the vehicle 102A sends the priority withdrawal request after concluding travel through the desired range.

In examples, where multiple vehicles have requested a priority lane, the RSU 108 may maintain the lane allocation 602 until all vehicles having requested the priority lane send priority withdrawal request. In yet further examples, the RSU 108 may automatically conclude the priority lane request responsive to passage of the vehicle 102A through the lane allocation 602 (e.g., as determined by the vehicle 102A sending a TUM 204 indicating passage of the vehicle 102A, via the infrastructure equipment 208 determining passage of the vehicle 102A, etc.

Responsive to receipt of the priority withdrawal request in the TUM 204, the RSU tolling application 222 of the RSU 108 may utilize the logic 412 to once again adjust the dynamic TAM elements 418 of the TAM 202. For instance, the RSU tolling application 222 may adjust the TAM 202 to again indicate that all lanes in the travel direction of the vehicle 102A are available for tolling vehicle use. The RSU 108 may then broadcast the updated TAM 202 to inform other vehicles 102 of the revised lane assignments. The RSU 108 may also send a TUM-ACK 206 message back to the vehicle 102A to inform it of the closure of the priority lane.

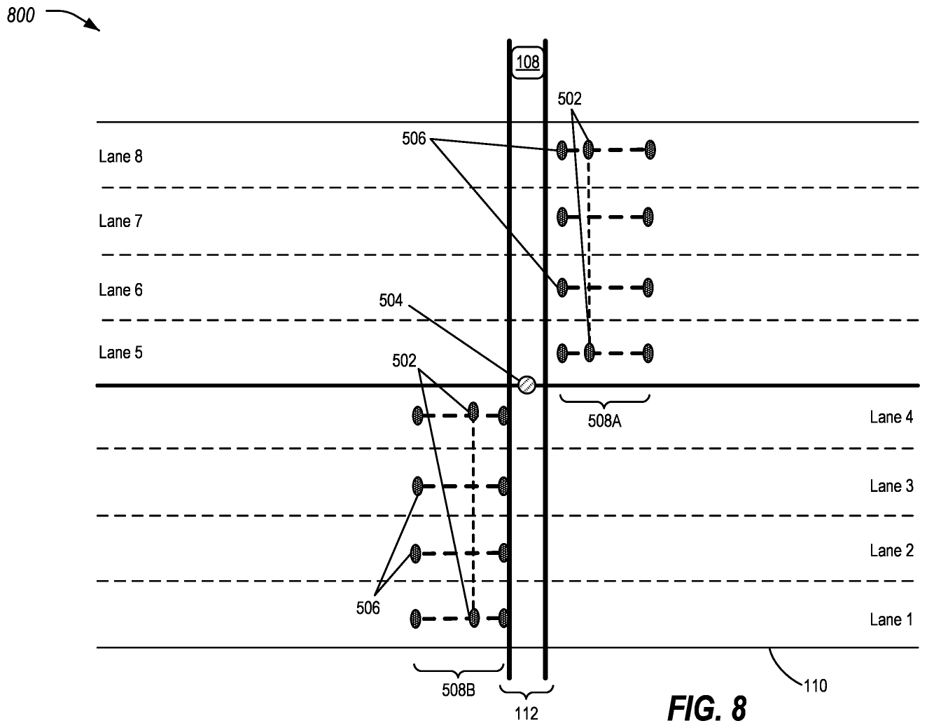

FIG. 8 illustrates an example 800 of the toll road geometry after removal of the allocation of a lane for priority vehicles. As can be seen, all lanes are again available for use for tolling.

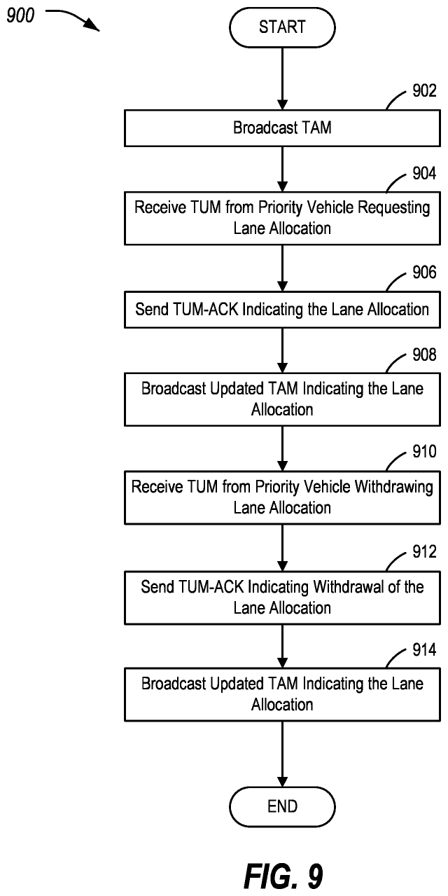

FIG. 9 illustrates an example process 900 for the performance of V2X tolling and lane allocation transactions from an infrastructure perspective. In an example, the process 900 may be performed by the RSU 108 executing the RSU tolling application 222, in the context of the system 100.

At operation 902, the RSU 108 broadcasts a TAM 202. The TAM 202 may include toll road geometry information with respect to the placement of lanes in a toll area, such as lane node offsets 502, reference points 504, and as toll trigger lines 506. The TAM 202 may also include rate information such as a toll rate schedule that identifies current rates for travel over the lanes of the roadway 110 as defined by the road geometry.

At operation 904, the RSU 108 receives a TUM 204 from a priority vehicle 102 requesting a lane allocation. In an example, the TUM 204 may include a priority request requesting that the priority vehicle 102 be granted a lane allocation 602 from the lanes of the roadway 110. The lane allocation 602 may include one or more lanes that are dedicated to travel by the priority vehicle 102, to the exclusion of other vehicles 102 along the roadway 110.

At operation 906, the RSU 108 sends a TUM-ACK 206 to the priority vehicle 102 indicating the lane allocation 602. For instance, the TUM-ACK 206 may specify to the priority vehicle 102 which lane or lanes are reallocated (or were previously reallocated for another priority vehicle) from tolling to dedicated use for priority vehicles 102.

At operation 908, the RSU 108 broadcasts an updated TAM 202 indicating the lane allocation to the priority vehicle 102 as well as to any other listening vehicles 102. Responsive to receipt of the priority request in the TUM 204, the RSU tolling application 222 of the RSU 108 may utilize the logic 412 to adjust the dynamic TAM elements 418 of the TAM 202. For instance, the RSU tolling application 222 may adjust the TAM 202 bring broadcast to indicate that one of the lanes in the travel direction of the vehicle 102A should be reallocated for priority vehicle use instead of for tolling vehicle use. The RSU 108 may then broadcast the updated TAM 202 to inform other vehicles 102 of the revised lane assignments.

At operation 910, the RSU 108 receives a second TUM 204 from the priority vehicle 102 to request withdrawal of the lane allocation. In an example, the second TUM 204 may indicate the priority withdrawal request responsive to the vehicle 102A no longer requiring the priority lane.

The TUM 204 may also, in some examples, specify the tariff owed by the vehicle 102A for the roadway 110 usage of the vehicle 102A if applicable, which may be used to charge the vehicle 102A. For instance, if the vehicle 102A is an ambulance or a service vehicle, then the vehicle 102A may not be charged (or if there is a charge it may be applied to a fleet or municipality). If, however, the vehicle 102A has priority because of paying for the priority, such as a vehicle of a bus line, then a payment may be due for usage of the lane of the roadway 110 in accordance with the toll rate schedule specified by the TAM 202. If a charge is due, the RSU 108 may complete that charging operation using the toll charger cloud 116.

At operation 912, the RSU 108 sends a TUM-ACK 206 to the priority vehicle 102 indicating the withdrawal of the lane allocation. Thus, the RSU 108 may inform the vehicle 102A of the closure of the priority lane.

At operation 914, the RSU 108 broadcasts an updated TAM 202 no longer indicating the lane allocation to the priority vehicle 102 as well as to any other listening vehicles 102. For instance, the RSU tolling application 222 of the RSU 108 may utilize the logic 412 to once again adjust the dynamic TAM elements 418 of the TAM 202. For instance, the RSU tolling application 222 may adjust the TAM 202 to again indicate that all lanes in the travel direction of the vehicle 102A are available for tolling vehicle use. The RSU 108 may then broadcast the updated TAM 202 to inform other vehicles 102 of the revised lane assignments. After operation 914, the process 900 ends.

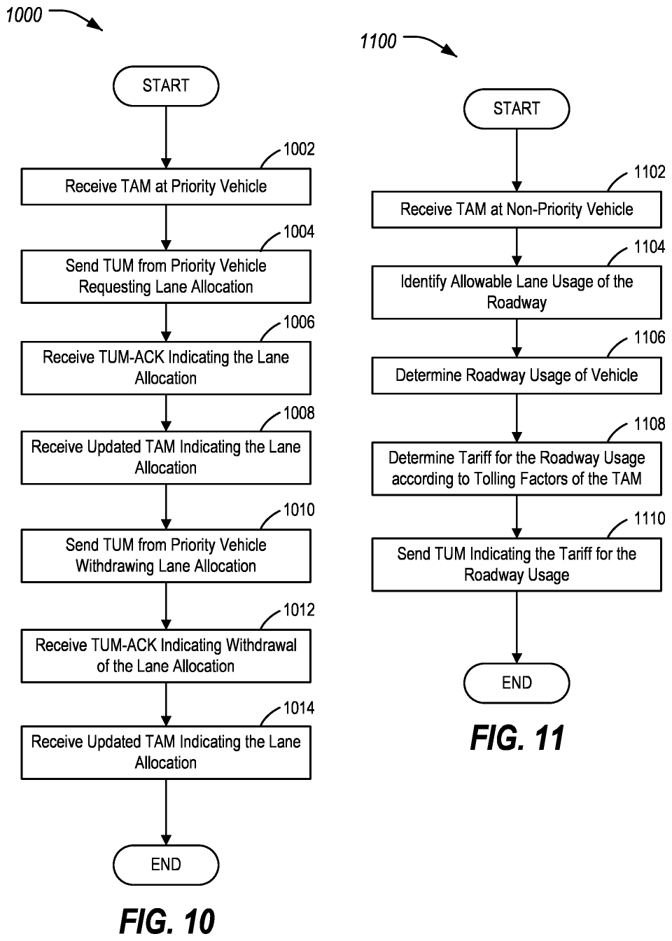

FIG. 10 illustrates an example process 1000 for the performance of V2X tolling and lane allocation transactions from a priority vehicle perspective. In an example, the process 1000 may be performed by the OBU 104 of a priority vehicle executing the OBU tolling application 220, in the context of the system 100.

At operation 1002, the OBU 104 receives a TAM 202 broadcast from the RSU 108. In an example, the TAM 202 may be broadcast as discussed with respect to operation 902.

At operation 1004, the OBU 104 sends a TUM 204 requesting a lane allocation to the RSU 108. In an example, the OBU 104 may determine that the vehicle 102 is a priority vehicle and may send the TUM 204 priority request as discussed with respect to operation 904. In some examples, the TUM 204 may include an estimated time of arrival of the vehicle 102 to the toll gantry 112 to allow the RSU 108 to allocate the timing of the lane allocation 602.

At operation 1006, as discussed with respect to operation 906, the OBU 104 receives a TUM-ACK 206 indicating the lane allocation 602. At operation 1008, as discussed with respect to operation 908, the OBU 104 receives an updated TAM 202 indicating the lane allocation to the priority vehicle 102 as well as to any other listening vehicles 102. The priority vehicle may now traverse the roadway 110 allocated to priority vehicles.

At operation 1010, the OBU 104 sends a second TUM 204 to request withdrawal of the lane allocation. In an example, as discussed with respect to operation 910, the second TUM 204 may indicate the priority withdrawal request responsive to the vehicle 102A no longer requiring the priority lane and/or specify the tariff owed by the vehicle 102A for the roadway 110 usage of the vehicle 102A if applicable.

At operation 1012, as discussed with respect to operation 912, the OBU 104 receives a second TUM-ACK 206 indicating the withdrawal of lane allocation 602. At operation 1014, as discussed with respect to operation 914, the OBU 104 receives an updated TAM 202 indicating no lane allocation to the priority vehicle 102. At this point the roadway 110 is no longer allocated to the priority vehicle. After operation 1014, the process 1000 ends.

FIG. 11 illustrates an example process 1100 for the performance of V2X tolling and lane allocation transactions from a non-priority vehicle perspective. In an example, the process 1100 may be performed by the OBU 104 of a non-priority vehicle executing the OBU tolling application 220, in the context of the system 100.

At operation 1102, the OBU 104 receives a TAM 202 broadcast from the RSU 108. In an example, the TAM 202 may be broadcast as discussed with respect to operation 902.

At operation 1104, the OBU 104 identifies allowable lane usage of the roadway 110. For instance, the OBU 104 utilizes the TAM 202 to determine which lanes of the roadway 110 are allocated to tolled vehicle access and which lanes have a lane allocation 602 for priority vehicle use. If the vehicle 102 includes autonomous or semi-autonomous functionality, the OBU 104 may prohibit such functionality from utilizing a lane allocation 602 for priority vehicle use if the vehicle 102 itself lacks that priority. The vehicle 102 may also so the lane allocation 602, if any, in the HMI of the vehicle 102 for display to vehicle occupants.

At operation 1106, the OBU 104 identifies utilizes toll road tariff data elements may specify a set of tolling factors indexed by a unique toll context identifier. For instance, the vehicle 102 may identify information such as the class of the vehicle 102, the time of day, the entrance to the roadway 110 used by the vehicle 102, the exit from the roadway 110 used by the vehicle 102, time spent in a cordon area by the vehicle 102, and/or distance traveled in the cordon area by the vehicle 102.

At operation 1108, the OBU 104 determines roadway usage of the vehicle 102 using the toll rate schedule from the TAM 202. The OBU 104 determines a tariff for the roadway usage according to the set of tolling factors of the TAM 202. For instance, the vehicle 102 may compare the information to the toll road tariff data elements to identify one of the toll road tariff data elements that best applies to the information of the vehicle 102 and may indicate that the charge is that amount.

At operation 1110, the OBU 104 sends a TUM 204 to indicate, to the RSU 108, the tariff for the roadway usage of the vehicle 102. After operation 1110, the process 1100 ends.

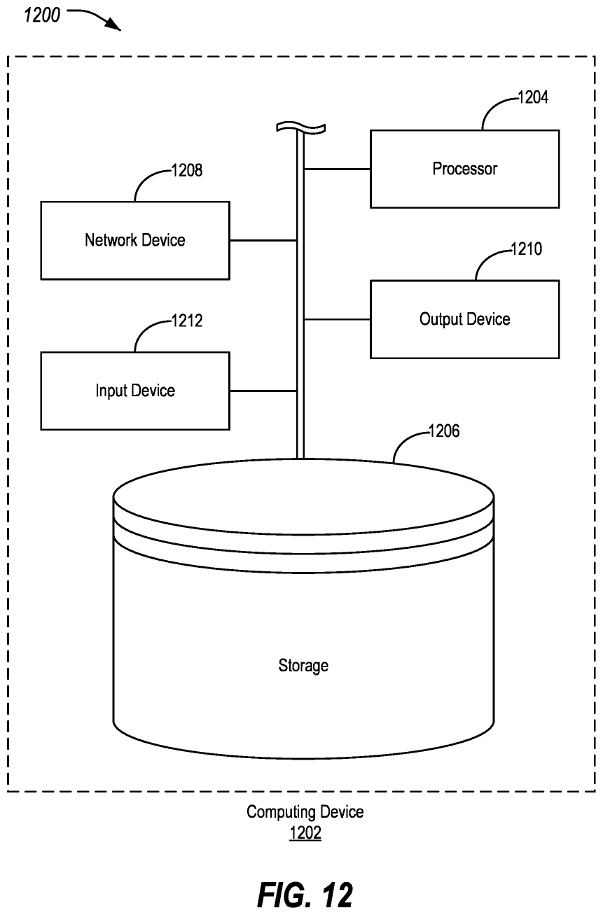

FIG. 12 illustrates an example 1200 of a computing device 1202 for use in the performance of V2X tolling transactions. Referring to FIG. 12, and with reference to FIGS. 1-11, the OBU 104, RSU 108, toll charger cloud 116, and toll service provider cloud 118 may be examples of such computing devices 1202. As shown, the computing device 1202 may include a processor 1204 that is operatively connected to a storage 1206, a network device 1208, an output device 1210, and an input device 1212. It should be noted that this is merely an example, and computing devices 1202 with more, fewer, or different components may be used.

The processor 1204 may include one or more integrated circuits that implement the functionality of a central processing unit (CPU) and/or graphics processing unit (GPU). In some examples, the processors 1204 are a system on a chip (SoC) that integrates the functionality of the CPU and GPU. The SoC may optionally include other components such as, for example, the storage 1206 and the network device 1208 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1204 executes stored program instructions that are retrieved from the storage 1206. The stored program instructions, accordingly, include software that controls the operation of the processors 1204 to perform the operations described herein. The storage 1206 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 1210. The output device 1210 may include a graphical or visual display device, such as an electronic display screen, projector, printer, or any other suitable device that reproduces a graphical display. As another example, the output device 1210 may include an audio device, such as a loudspeaker or headphone. As yet a further example, the output device 1210 may include a tactile device, such as a mechanically raiseable device that may, in an example, be configured to display braille or another physical output that may be touched to provide information to a user.

The input device 1212 may include any of various devices that enable the computing device 1202 to receive control input from users. Examples of suitable input devices that receive human interface inputs may include keyboards, mice, trackballs, touchscreens, voice input devices, graphics tablets, and the like.

The network devices 1208 may each include any of various devices that enable the OBU 104, RSU 108, toll charger cloud 116, and toll service provider cloud 118 to send and/or receive data from external devices over networks (such as the communications network). Examples of suitable network devices 1208 include an Ethernet interface, a Wi-Fi transceiver, a cellular transceiver, a satellite transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for smart tolling and lane allocation, comprising:
a transceiver configured to provide vehicle-to-everything (V2X) communication; and
a roadside unit (RSU), including a hardware processor, programmed to
broadcast a first toll advertisement message (TAM), the first TAM indicating geographic locations of lanes of a roadway for which tolls are due and payment information for traversing the lanes of the roadway,
receive a tolling usage message (TUM) from a first priority vehicle in receipt of the first TAM, the TUM including a request to reallocate one or more of the lanes of the roadway for use by the first priority vehicle, and
responsive to receipt of the TUM, send a TUM acknowledgment to the first priority vehicle indicating a lane allocation for use by the first priority vehicle and broadcast a second TAM indicating the geographic locations of lanes of the roadway for which the tolls are due, the payment information for traversing the lanes of the roadway, and the lane allocation indicating which of the one or more of the lanes of the roadway are for use by priority vehicles.

2. The system of claim 1, wherein the TUM includes an estimated time of arrival of the first priority vehicle to a toll gantry corresponding to the RSU, wherein the RSU utilizes the estimated time of arrival to time the lane allocation.

3. The system of claim 1, wherein the RSU is further programmed to:
receive a second TUM from the first priority vehicle, the second TUM indicating that the first priority vehicle has completed use of the lane allocation, and
broadcast a third TAM, the third TAM indicating the geographic locations of lanes of the roadway for which the tolls are due and the payment information for traversing the lanes of the roadway again without the lane allocation.

4. The system of claim 1, wherein the first priority vehicle is not charged for use of the one or more of the lanes of the lane allocation.

5. The system of claim 1, wherein the priority vehicle is an ambulance, a police car, a municipal vehicle, or a service vehicle.

6. The system of claim 1, wherein the RSU is further programmed to:
receive a second tolling usage message (TUM) from a non-priority vehicle in receipt of the second TAM, the second TUM indicating usage of the roadway by the non-priority vehicle; and
utilize a toll charger to charge the non-priority vehicle for the usage of the roadway.

7. The system of claim 1, wherein the RSU is further programmed to:
receive, a second tolling usage message (TUM) from a second vehicle in receipt of the second TAM, the second vehicle being a priority vehicle, the second TUM including a second request to reallocate one or more of the lanes of the roadway for use by the second vehicle; and
responsive to receipt of the second TUM, send a second TUM acknowledgment to the second vehicle indicating the lane allocation as previously allocated for the first priority vehicle is available for use by the second priority vehicle.

8. The system of claim 1, wherein the RSU is further programmed to:
receive, a second tolling usage message (TUM) from a second vehicle in receipt of the second TAM, the second vehicle being a non-priority vehicle, the second TUM including a second request to reallocate one or more of the lanes of the roadway for use by the second vehicle; and
responsive to receipt of the second TUM, send a second TUM acknowledgment to the second vehicle denying the second request for the lane allocation due to the second vehicle being a non-priority vehicle.

9. A method for smart tolling and lane allocation, comprising:
broadcasting, from a roadside unit (RSU), a first toll advertisement message (TAM), the first TAM indicating geographic locations of lanes of a roadway for which tolls are due and payment information for traversing the lanes of the roadway,
receiving, by the RSU, a tolling usage message (TUM) from a first priority vehicle in receipt of the first TAM, the TUM including a request to reallocate one or more of the lanes of the roadway for use by the first priority vehicle, and
responsive to receipt of the TUM, sending, from the RSU, a TUM acknowledgment to the first priority vehicle indicating a lane allocation for use by the first priority vehicle and broadcast a second TAM indicating the geographic locations of lanes of the roadway for which the tolls are due, the payment information for traversing the lanes of the roadway, and the lane allocation indicating which of the one or more of the lanes of the roadway are for use by priority vehicles.

10. The method of claim 9, wherein the RSU is further programmed to:
receiving, by the RSU, a second TUM from the first priority vehicle, the second TUM indicating that the first priority vehicle has completed use of the lane allocation, and
broadcasting, by the RSU, a third TAM, the third TAM indicating the geographic locations of lanes of the roadway for which the tolls are due and the payment information for traversing the lanes of the roadway again without the lane allocation.

11. The method of claim 9, wherein the first priority vehicle is not charged for use of the one or more of the lanes of the lane allocation.

12. The method of claim 9, wherein the priority vehicle is an ambulance, a police car, a municipal vehicle, or a service vehicle.

13. The method of claim 9, further comprising:
receiving, by the RSU, a second tolling usage message (TUM) from a non-priority vehicle in receipt of the second TAM, the second TUM indicating usage of the roadway by the non-priority vehicle; and
utilizing a toll charger to charge the non-priority vehicle for the usage of the roadway.

14. The method of claim 9, further comprising:
receiving, a second tolling usage message (TUM) from a second vehicle in receipt of the second TAM, the second vehicle being a priority vehicle, the second TUM including a second request to reallocate one or more of the lanes of the roadway for use by the second vehicle; and
responsive to receipt of the second TUM, sending a second TUM acknowledgment to the second vehicle indicating the lane allocation as previously allocated for the first priority vehicle is available for use by the second priority vehicle.

15. The method of claim 9, further comprising:
receiving, a second tolling usage message (TUM) from a second priority vehicle in receipt of the second TAM, the second TUM including a second request to reallocate one or more of the lanes of the roadway for use by the second priority vehicle; and
responsive to receipt of the second TUM, sending a second TUM acknowledgment to the second priority vehicle denying the second request responsive to the second priority vehicle being of lower priority than the first priority vehicle.

16. A vehicle for smart tolling and lane allocation, comprising:
a transceiver configured to provide vehicle-to-everything (V2X) communication; and
an on-board unit (OBU), including a hardware processor, programmed to
receive a first toll advertisement message (TAM) broadcast from a roadside unit (RSU), the first TAM indicating geographic locations of lanes of a roadway for which tolls are due and payment information for traversing the lanes of the roadway,
send a tolling usage message (TUM) to the RSU, the TUM including a request to reallocate one or more of the lanes of the roadway for use by the vehicle, and
receive, responsive to sending the TUM, a TUM acknowledgment indicating a lane allocation for use by the vehicle and a second TAM broadcast indicating the geographic locations of lanes of the roadway for which the tolls are due, the payment information for traversing the lanes of the roadway, and the lane allocation indicating which of the one or more of the lanes of the roadway are for use by priority vehicles.

17. The vehicle of claim 15, wherein the OBU is further programmed to send a second TUM to the RSU, the second TUM indicating that the vehicle has completed use of the lane allocation.

18. The vehicle of claim 17, wherein the OBU is further programmed to receive a third TAM from the RSU responsive to sending the second TUM, the third TAM indicating the geographic locations of the lanes of the roadway for which the tolls are due and the payment information for traversing the lanes of the roadway again without the lane allocation.

19. The vehicle of claim 17, wherein the OBU is further programmed to receive a third TAM from the RSU responsive to sending the second TUM, the third TAM indicating the lane allocation is still be used by other vehicles.

20. The vehicle of claim 16, wherein the vehicle is not charged for use of the one or more of the lanes of the roadway for use by priority vehicles.

21. The vehicle of claim 16, wherein the vehicle is an ambulance, a police car, a municipal vehicle, or a service vehicle.

22. The vehicle of claim 16, wherein the TUM acknowledgment to the vehicle indicates the lane allocation as previously allocated for another priority vehicle.
